(19) United States
(12) Patent Application Publication
(10) Pub. No.: US 2017/0364071 A1
(43) Pub. Date: Dec. 21, 2017

(54) SYSTEMS AND METHODS FOR DUAL OPERATION OF UNMANNED AERIAL VEHICLES

(71) Applicant: University of North Texas, Denton, TX (US)

(72) Inventors: Shengli Fu, Denton, TX (US); Yan Wan, Denton, TX (US)

(21) Appl. No.: 15/625,822

(22) Filed: Jun. 16, 2017

Related U.S. Application Data
(60) Provisional application No. 62/351,209, filed on Jun. 16, 2016.

(51) Int. Cl. G05D 1/00; B64C 39/02

(52) U.S. Cl. CPC G05D 1/0061; G05D 1/0088; G05D 1/0011; B64C 39/024; B64C 2201/141; B64C 2201/146

(57) ABSTRACT

An unmanned aerial vehicle (UAV) dual operation system and method is described. Certain embodiments include a dual operation system that receives and processes control signals from two controllers, e.g., a first controller and a second controller, and outputs a control signal to a UAV on-board pilot system to operate the UAV. In some embodiments, the dual operation system may override control signals from the first controller with the control signals received from the second controller. Further, the dual operation system may respond to various conditions when control signals from one of the controllers are lost or unstable, enabling an on-board pilot system to take over control of the UAV.

### CROSS-REFERENCE TO RELATED APPLICATION

The present application claims the benefit of U.S. Provisional Patent Application No. 62/351,209, filed on Jun. 16, 2016, the contents of which are incorporated herein by reference in their entirety.

### GOVERNMENT INTEREST

This invention was made with government support under Grants IIP 1508082 and CNS 1522458, awarded by the National Science Foundation. The government has certain rights in the invention.

### TECHNICAL FIELD

The present application relates generally to unmanned aerial vehicles and, more particularly, a dual operation system and method for the control of unmanned aerial vehicles.

### BACKGROUND

As commercial applications for unmanned aerial vehicles (UAV) become more ubiquitous, there is an increased need for qualified UAV operators who can safely control UAVs to prevent potential damage to people, property, and the UAV itself. Safety is especially important while training new UAV operators. In many cases, significant training is required in order to safely operate UAVs, especially considering the numerous types of UAVs, e.g., fixed-wing and multi-rotor UAVs.

UAV systems are typically paired with a single operator's controller unit. UAV navigation generally relies on global positioning systems (GPS) and wireless commands received from the operator's controller. These systems, however, have significant limitations. For example, if the operator fails to safely control the UAV, the UAV may be lost and/or damaged. In addition, if a UAV fails to receive a wireless control signal or a GPS signal (e.g., due to range or interference issues), the UAV may lose control during flight. As such, there is a need for an improved system to ensure safe operation of UAVs, especially in the training context.

### SUMMARY

The present application is directed to systems and methods that provide for safer operation of a UAV, wherein a dual operation system interacts with a plurality of controllers to facilitate UAV operation. Certain embodiments include a system and method wherein a dual operation system receives and processes control signals from two controllers, e.g., a first controller and a second controller, and outputs a control signal to a UAV on-board pilot system to operate the UAV. A dual operation system may determine to override control signals from a first controller with the control signals received from a second controller.

In certain embodiments, a dual operation system comprises one or more transceivers, a control decision system, a memory system, a power system, and a sensor system. The one or more transceivers receive control signals from a plurality of controllers, and output control signals to a UAV to operate the UAV. The control decision system logic processes sensor information from a UAV and UAV control signals received from the plurality of controllers. The control decision system processes received signals and sends UAV control commands to maintain safety of the UAV. The dual operation system may also respond to various conditions and enable an on-board pilot system to take over control.

In certain embodiments, a plurality of controllers may comprise a first controller and a second controller. The first controller may be operated by a trainee and transmits UAV control signals to a dual operation system. The second controller may be operated by a trainer and transmits UAV control signals to the dual operation system. In one embodiment, the second controller has an override protocol, which if activated, may allow for taking over control from the first controller. In other embodiments, received signals from second controller may cause an automatic override.

In an embodiment, a control system for an unmanned aerial vehicle includes at least one processor configured to receive a control signal from a first controller, receive a control signal from a second controller, determine whether the first controller signal should be overridden by the second controller signal, and output the determined control signal to the unmanned aerial vehicle. In another embodiment, a method for controlling an unmanned aerial vehicle includes receiving a control signal from a first controller; receiving a control signal from a second controller, determining, based on received signals, whether the first control signal should be overridden by the second control signal, and outputting the determined control signal to the unmanned aerial vehicle. In yet another embodiment, a non-transitory computer-readable storage medium stores instructions that, when executed by a processor, cause the processor to perform operations including receiving a control signal from a first controller, receiving a control signal from a second controller, determining, based on received signals, whether the first control signal should be overridden by the second control signal, and outputting the determined control signal to the unmanned aerial vehicle.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 illustrates a UAV system in accordance with an embodiment of the present application;

FIG. 2 illustrates a dual operation system in accordance with an embodiment of the present application;

FIG. 3 illustrates a flow diagram for a dual operation system algorithm in accordance with an embodiment of the present application; and

FIG. 4 illustrates a flow diagram for a dual operation method in accordance with an embodiment of the present application.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are exemplary by way of illustration only, and not by way of limitation. Various substitutions, modifications, additions, and/or rearrangements within the spirit and/or scope of the underlying inventive concept will become apparent to those skilled in the art from this disclosure.

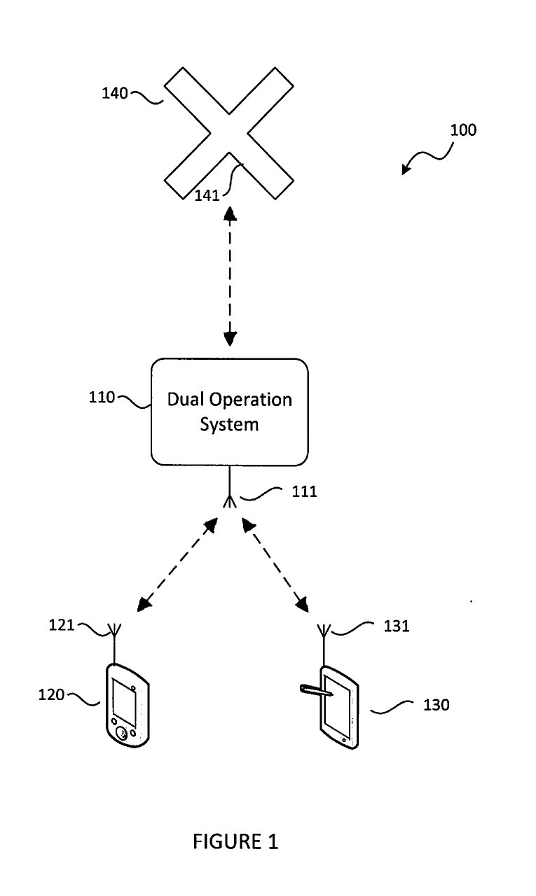

FIG. 1 illustrates a UAV system 100 in accordance with an embodiment of the present application. UAV system 100 may include dual operation system 110, first controller 120, second controller 130, and UAV 140. While the present discussion assumes a dual operation system as logic/processing on a UAV, it is appreciated that dual operation system 110 may be separate from UAV 140. For instance, dual operation system 110 may be a stand-alone system that communicates with the separate components of UAV system 100, e.g., first controller 120, second controller 130, and UAV 140. In one embodiment, dual operation system 110 may be integrated with first controller 120. In another embodiment, dual operation system 110 may be integrated with second controller 130. While UAV system 100 is illustrated in FIG. 1 as using wireless communication, some components may be wired (e.g., connections between a first and second controller), wireless, or any combination thereof. While UAV 140 is illustrated as a quadcopter, it is appreciated that UAV system 100 may include any type of UAV. For instance, UAV 140 may include hexa-rotors, fixed-wings, or any other type of UAV.

In one embodiment, dual operation system 110 is configured to receive a control signal from first controller 120 and a control signal from second controller 130. As will be discussed in further detail, dual operation system 110 processes the received control signals and outputs a control signal to on-board pilot system 141 to control UAV 140. On-board pilot system 141 controls UAV 140 based on received control signals. Additionally, in some embodiments, on-board pilot system 141 may control UAV 140 automatically, e.g., with an autopilot system. UAV 140 may also be equipped with antennas to receive UAV control signals and transmit flight status information, e.g., altitude, speed, direction, etc.

In certain embodiments, first controller 120 may be a primary controller that generally has priority over second controller 130 for controlling UAV 140. In one embodiment, first controller 120 may be operated by a trainee and referred to as a main controller. Second controller 130 may be operated by a trainer (e.g., a flight training instructor) and called a trainer controller. For example, first controller 120 may be operated by a trainee such that dual system 110 prioritizes the signals from first controller 120. Second controller 130 may be able to take over when there are certain conditions present (e.g., the trainee fails to safely control UAV 140, an override is enabled, the trainer manipulates the controller in some way to indicate UAV 140 should be controlled by second controller 130). In another example, first controller 120 may be referred to as a slave controller, and second controller 130 may be referred to as a master controller. For instance, while the slave controller typically has control over a UAV, the master control may override and take control depending on conditions described herein.

It is appreciated that first controller 120 and second controller 130 may include any type of UAV controller. For instance, controllers may include general controllers, computer based controllers, and specific controllers built for a particular UAV. In some embodiments, first controller 120 and second controller 130 may include a UAV control application implemented on smart devices, laptops, and the like. For example, a first and second smartphone may be paired with a UAV where the first smart phone acts as first controller 120 and the second smartphone acts as second controller 130. It is appreciated that UAV system 100 may comprise additional controllers. For example, in one embodiment, UAV 140 may be operated by three controllers, wherein two trainees operate separate controllers (e.g., alternating control during the same training flight) and wherein a trainer operates a third controller. For instance, a trainer may establish who controls the UAV at any given time via an override protocol and the like.

In certain embodiments, first controller 120 and second controller 130 transmit and receive signals via antenna 121 and antenna 131, respectively. Dual operating system 110 receives control signals from first controller 120 and second controller 130 via antenna 111. Antennas 111, 121, and 131 may include any type of antenna, e.g., omni-directional or directional, as set forth in this application. Additionally, antennas 111, 121, and 131 may be implemented as one or more antenna arrays depending on the type/format of communication implemented by the system.

Communication between first controller 120, second controller 130, and dual operation system 110 is not restricted to any particular form of communication protocol. It is appreciated that communication between first controller 120, second controller 130, and dual operation system 110 may be wired or wireless or any combination thereof. In one embodiment, first controller 120 and second controller 130 may include an application on a smart device as previously discussed, and therefore may communicate over any one of GSM, CDMA, 3G/4G/5G, WiMAX, LTE, and the like. It is appreciated that there are no set standards for which the controllers to communicate, and that the inventive concepts described herein are easily adaptable to the implemented using different communication methods.

First controller 120, second controller 130, and dual operation system 110 may use protocols that include different frequencies, modulation/demodulations, coding/decoding schemes, etc. First controller 120 and second controller 130 may operate at a range of different channels based on the configuration of the controllers. Further, first controller 120 and second controller 130 may operate on the same frequency and channel, a different frequency and channel, or any combination thereof. In one embodiment, the wireless channels of first controller 120 and dual operation system 110 may be configured during a configuration mode. In a configuration mode, first controller 120 and second controller 130 may negotiate with and confirm with dual operation system 110 on the channels to be used during operation.

In one embodiment, second controller 130 may include a functional override protocol (e.g., a button/switch of any form), which if “on”, indicates that the control signals from second controller 130 are executed, regardless of what control signals are sent from first controller 120. In another embodiment, first controller 120 may have a similar override protocol that would enable a first controller 120 to override signals from second controller 130. For example, in the event that one controller is malfunctioning or an operator is improperly controlling UAV 140, the signal may be overridden by activating the override protocol to ensure the safe operation of UAV 140. The form of the override protocol may include a physical switch, a button on an application installed on a smart device, and/or a protocol of any other form.

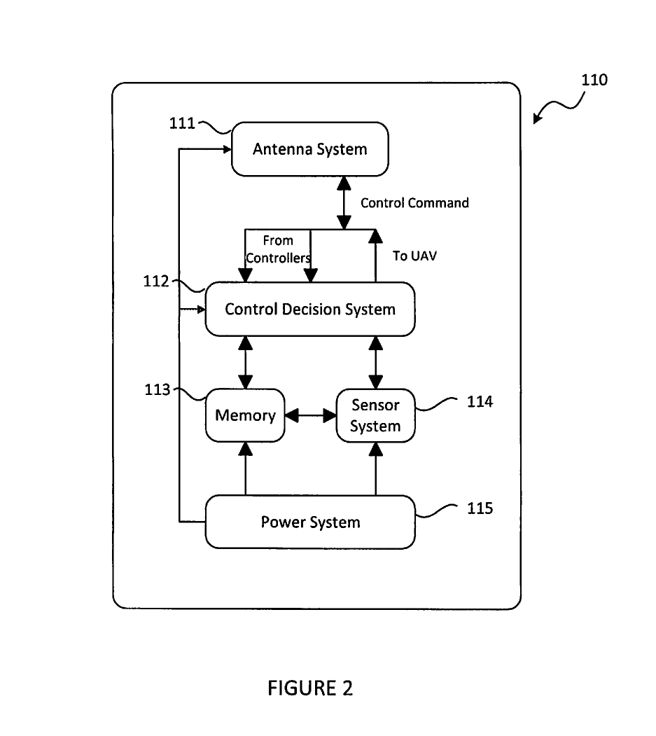

FIG. 2 illustrates components of dual operation system 110 in accordance with an embodiment of the present application. Control decision system 112 may be implemented on a computing device of any form, e.g., a microcontroller, FPGA, ASIC, etc. Control decision system 112 receives control signals from first controller 120 and second controller 130 through antenna system 111, and outputs a control signal to UAV 140.

While dual system 110 will generally be on-board a UAV, in certain embodiments, when a wireless link is used for signals between UAV 140 and dual operation system 110, no physical interface to on-board pilot system 141 is needed. For example, wireless communication may be preferable when on-board pilot system 141 is sealed during the manufacturing process and no modification is permitted. In an embodiment comprising wireless communication between control decision system 112 and on-board pilot system 141 of UAV 140, the wireless channels may be configured during a configuration mode. In an alternative implementation, dual operation system 110 may be an attachable module which interfaces with UAV 140, and communication between control decision system 112 and UAV 140 may be wired through a serial port or any similar interface. In yet another system, second controller 130 may communicate with first controller 120, which in turn communicates with dual operation system 110.

Sensor system 114 may provide status information to the control decision system 112. Status information may include UAV speed, acceleration, altitude, and any other information that indicates the status of UAV 140, including the availability of GPS signal, heading direction, battery life, etc. In an alternative implementation, some UAV status information may also be received from the UAV on-board pilot system 141.

Memory system 113 supports the storage of system setup parameters and the implementation of any control decision algorithm in control decision system 112. Memory system 113 may comprise random access memory (RAM), read only memory (ROM), disk memory, optical memory, etc. Memory system 113 may also be connected to sensor system 114 to store past sensor data. Memory system 113 may also be connected to control decision system 112 to store algorithms, internal data, and the like. Power system 115 provides power the components of dual operation system 110, including antenna system 111, control decision system 112, memory system 113, and sensor system 114.

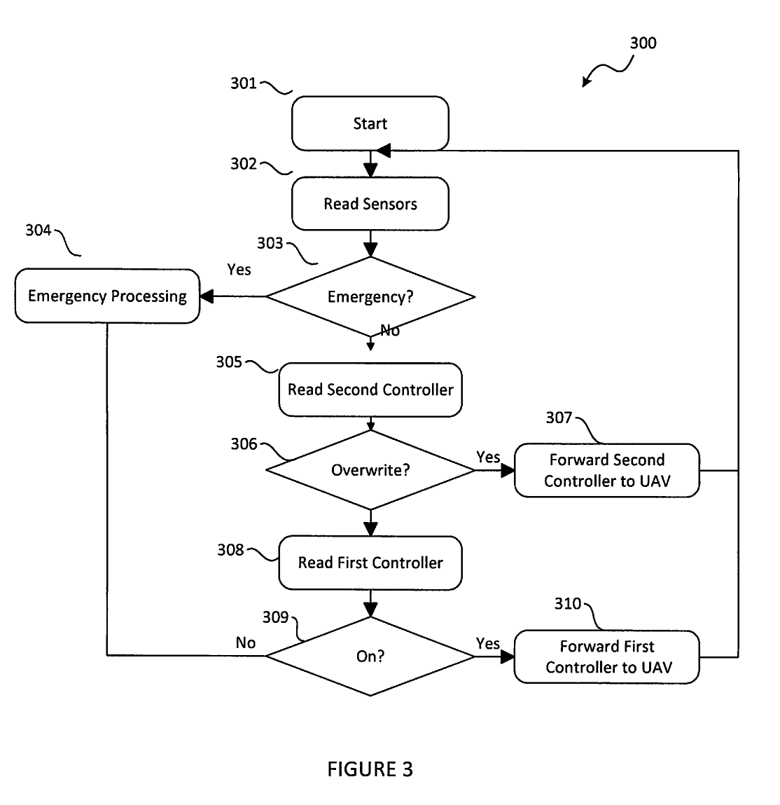

FIG. 3 illustrates an algorithm 300 for dual operation of UAV 140 in accordance with an embodiment of the present application. It is noted that algorithm 300 may be implemented within one or more systems described above. Algorithm 300 is processed based on readings from sensor system 114 and UAV control signals from first controller 120 and second controller 130. Algorithm 300, starting at block 301, may be implemented at every clock cycle. Algorithm 300 includes, at block 302, reading from sensor system 114 and at block 303, deciding if there is an emergency. If there is an emergency, the system enters the emergency processing mode at block 304. For example, emergency triggers may include unavailability of a GPS signal for a certain duration, instability of UAV 140 indicated by its speed and acceleration sensors, low battery capacity, lack of contact with one or more controllers, etc. In emergency processing mode, UAV 140 conducts a series of operations to maintain its safety. For instance, emergency operations may include using its own speed and acceleration sensors (e.g., an auto-pilot system) to guide safe landing, decrease speed, change directions/heading, return to safe operation, etc. In another embodiment, emergency processing mode may be entered using interrupts and other parallel implementation mechanisms.

At block 303, if it is determined there is no emergency, emergency processing mode is not triggered, and a read trainer operation at block 305 is executed. In this operation, a UAV control signal from second controller 130 is read and parsed. At block 306, if the “Overwrite” status in the parsed reading is on, indicating that second controller 130 is controlling UAV 140, at block 307, second controller 130 control signal is forwarded to UAV 140. Alternatively, at block 306, if the “Overwrite” status in the parsed reading is off, a UAV control signal from first controller 120 is read at block 308. An overwrite may be triggered in multiple ways. For example, if an override protocol (e.g., a button/switch) is activated, if there is any control input from second controller 130 (e.g., an input from an operator to correct improper operation of another operator), and if there is any control from first controller, etc.

At block 309, if the reading is successful, e.g., the communication from first controller 120 is on, the UAV control signal received from first controller 120 is forwarded to UAV 140 in block 310. Alternatively, at block 309, if the reading is unsuccessful, e.g., if there is no communication from both first controller 120 and second controller 130, the system enters the emergency processing mode at block 304.

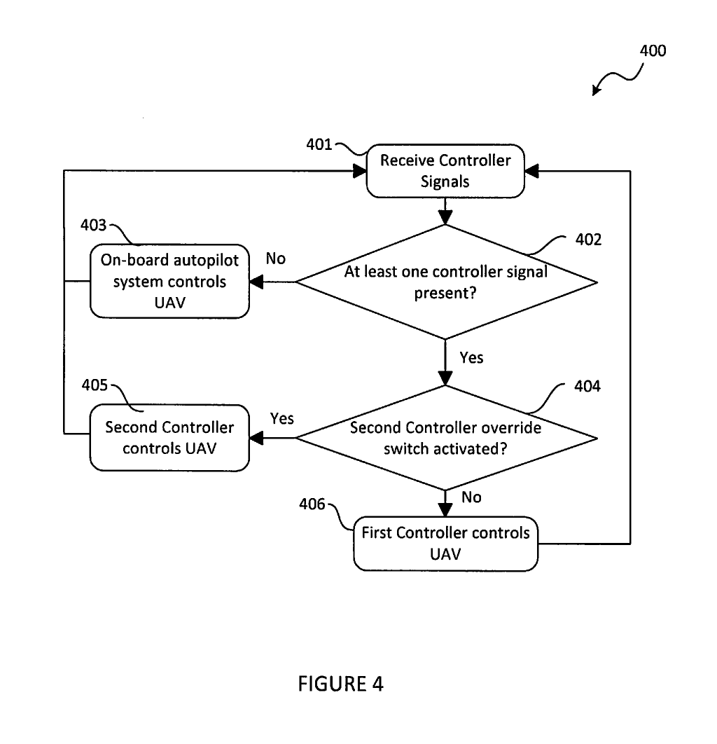

FIG. 4 illustrates a method 400 for dual operation of UAV 140 in accordance with an embodiment of the present application. At block 401, dual operation system 110 receives signals from a plurality of controllers. At block 402, if no signals are received (e.g., there is a communication interruption, the signals are unstable, communication systems are down), control of UAV 140 is diverted to on-board pilot system 141 (e.g., auto-pilot system controls UAV 140 as discussed herein). The system is continuously monitored such that if communication is restored, determination at block 402 may be re-evaluated. If there is at least one controller signal present, at block 404, dual operation system 110 determines if an override protocol is activated. If there is an override protocol activated, the controller on which the protocol is activated controls UAV 140 at block 405. For example, if second controller 130 override protocol is activated, at block 405, second controller 130 may control UAV 140. In the alternative, if first controller 120 override protocol is activated, first controller 120 controls UAV 140. If, at block 404, it is determined that no override protocol is activated, operation of UAV 140 is controlled by first controller 120 at block 406. Controller signals are continuously monitored and processed through the flow accordingly. For example, if first controller 120 is controlling UV 140, and an override protocol is activated (including any other scenario in which override is triggered as discussed herein, e.g., an automatic override process is present), UAV 140 is controlled by second controller 130.

It is noted that the functional blocks and modules in FIGS. 1-4 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A control system for an unmanned aerial vehicle comprising:
at least one processor configured to:
receive a control signal from a first controller;
receive a control signal from a second controller;
determine whether the first controller signal should be overridden by the second controller signal; and
output, to the unmanned aerial vehicle, the determined control signal.

2. The system of claim 1 wherein the at least one processing device is further configured to receive a signal from an unmanned aerial vehicle sensor comprising sensor data relating to unmanned aerial vehicle flight data.

3. The system of claim 2 wherein the flight data includes speed, acceleration, altitude, GPS signal, heading direction, and battery life.

4. The system of claim 1 wherein the at least one processing device is further configured to monitor for one or more emergency conditions present at the unmanned aerial vehicle.

5. The system of claim 4 wherein the emergency conditions include unavailability of a GPS signal, instability of the unmanned aerial vehicle, and low battery capacity.

6. The system of claim 4 wherein the emergency conditions include unstable communication with one or more controllers of the first and the second controllers.

7. The system of claim 4 wherein emergency procedures are implemented upon one or more of the emergency conditions.

8. The system of claim 7 wherein the emergency procedures include an on-board pilot system taking over control, wherein the on-board pilot system includes automatically adjusting speed, heading, and landing.

9. The system of claim 1 wherein the first controller is a slave controller configured to transmit flight control signals to the unmanned aerial vehicle.

10. The system of claim 9 wherein the second controller is a master controller configured to transmit flight control signals to the unmanned aerial vehicle.

11. The system of claim 10 wherein the master controller control signal overrides the slave controller control signal upon an override protocol being activated.

12. The system of claim 10 wherein the master controller control signal overrides the slave controller control signal when the master controller is manipulated.

13. The system of claim 10 wherein the master controller control signal overrides the slave controller control signal when communication from the slave controller is lost.

14. The system of claim 10 wherein an autopilot system controls the unmanned aerial vehicle upon lost communication from the master controller and the slave controller.

15. A method for controlling an unmanned aerial vehicle, the method comprising:
receiving, by at least one processing device, a control signal from a first controller;
receiving, by the at least one processing device, a control signal from a second controller;
determining, by the at least one processing device, based on received signals, whether the first control signal should be overridden by the second control signal; and
outputting, by the at least one processing device, to the unmanned aerial vehicle, the determined control signal.

16. The method of claim 15 further comprising monitoring for one or more emergency conditions present at the unmanned aerial vehicle.

17. The method of claim 16 wherein the emergency conditions include unstable communication with one or more of the first controller and the second controller.

18. The method of claim 15 wherein the first controller is a slave controller configured to transmit flight control signals to the unmanned aerial vehicle.

19. The method of claim 18 wherein the second controller is a master controller configured to transmit flight control signals to the unmanned aerial vehicle.

20. The method of claim 19 wherein the master controller control signal overrides the slave controller control signal upon an override protocol being activated.
